(19) United States
(12) Patent Application Publication
(10) Pub. No.: US 2003/0042319 A1
(43) Pub. Date: Mar. 6, 2003

(54) Automatic and semi-automatic index generation for raster documents

(75) Inventor: Lee C. Moore, Rochester, NY (US)

Correspondence Address: Patrick R. Roche, Esq., Fay, Sharpe, Fagan, Minnich & McKee, LLP, 1100 Superior Avenue, 7th Floor, Cleveland, OH, 44114-2518, US

(73) Assignee: XEROX CORPORATION

(21) Appl. No.: 09/944,536

(22) Filed: Aug. 31, 2001

(51) Int. Cl. G06K 19/06

(52) U.S. Cl. 235/494

(57) ABSTRACT

A system and method for automatic and semi-automatic document indexing preferably performs document recognition procedures on scanned document data and searches for sub-section delimiters. An index or table of contents is then generated for the document based on sub-section delimiters located in the search. For example, text strings, font size, or other symbols or distinguishing characteristics are used as delimiters in order to automatically find chapter or sub-section headings. A system operator may make adjustments to the automatically determined subdivisions. Alternatively, a plurality of document pages is displayed, for example, in thumbnail form, and the system operator indicates subdivision demarcation points within the displayed thumbnails. The indicated demarcation points are used as sub-section delimiters, and document subdivision is performed as described above. In yet another alternative, demarcation symbols are added to the document prior to scanning.

### BACKGROUND OF THE INVENTION

1. Field of the Invention

This invention relates to the art of automatic index or table of contents generation for documents. For example, the invention is useful where a large document is scanned to generate an electronic version of the document. The invention is used to automatically generate a table of contents of the document. The automatically generated table of contents greatly eases the task of document preparation and navigation.

2. Description of Related Art

When documents are scanned into electronic form in a document processor, the scanning process creates a file made up of individual sheets or images. Navigating a document in this form can be cumbersome For example, a document user may have to visually review many pages in order to find a particular chapter in the document. It is desirable therefore, to have an electronic listing of chapters and/or sub-sections, wherein the document users can quickly find a subject heading related to information the document user is looking for. Where such an electronic listing is available, the document user simply clicks on a subject or chapter heading (or otherwise indicates a portion of interest of the document) and that portion of the document is automatically displayed or otherwise made available.

Presently, for scanned documents, such electronic listings must be manually generated. For example, a document processor operator reviews a document and creates the electronic listing by entering chapter and sub-section titles in association with page numbers or other document location information. For large documents, this can be a time consuming and error prone task. It is desirable, therefore, to increase the accuracy and productivity of the task of electronic chapter and sub-section listing generation by automating some or all of the process.

### BRIEF SUMMARY OF THE INVENTION

To that end, a method for automatically indexing a document has been developed. The method comprises the procedures of determining a sub-section delimiter definition for the document, searching the document to find occurrences of the defined sub-section delimiter, and, using found sub-section delimiter occurrences to create an index for the document.

For example, in some embodiments the procedure of determining a sub-section delimiter includes indicating at least one of a font size, a font, a text string, a text location, a symbol, and a specific point within the document to be used as the sub-section delimiter. For instance, in a document where chapter headings are the only text printed in an 18-point font size, a sub-section or chapter delimiter is defined to include the 18-point font size. The document is searched for occurrences of 18-point text Occurrences of 18-point text are copied and saved in association with their location within the document. The saved information is used to create an electronic index.

In some embodiments, the procedure of determining a sub-section delimiter includes adding a special symbol to a demarcation point on a printed version of the document. For example, before the document is scanned, pages containing chapter headings or other sub-sections are marked with a special symbol. The special symbol is operative to indicate to the document processor that the page contains a chapter heading or other sub-section.

One advantage of the present invention resides in an increased accuracy in document sub-section location listing, provided by automated sub-section location identification.

Another advantage of the present invention is found in a reduction in required index generation labor provided by automated sub-section searching and index generation.

Still other advantages of the present invention will become apparent to those skilled in the art upon a reading and understanding of the detail description below.

### BRIEF DESCRIPTION OF THE SEVERAL VIEWS OF THE DRAWINGS

The invention may take form in various components and arrangements of components, and in various procedures and arrangements of procedures. The drawings are only for purposes of illustrating preferred embodiments, they are not to scale, and are not to be construed as limiting the invention.

FIG. 1 is a view of an electronic version of a document in association with an electronic index or table of contents.

FIG. 2 is a flow chart outlining a method operative to automatically generate an electronic index or table of contents.

FIG. 3 is a flow chart outlining a first embodiment of a portion of the method of FIG.2.

FIG. 4 is a flow chart outlining a second embodiment of a portion of the method of FIG.2.

FIG. 5 is a view of a plurality of thumbnails of pages or sheets of a document

FIG. 6 is a flow chart outlining a third embodiment of a portion of the method of FIG.2.

FIG. 7 is a flow chart outlining a fourth embodiment of a portion of the method of FIG.2.

FIG. 8 is a flow chart outlining a fifth embodiment of a portion of the method of FIG.2.

FIG. 9 is a block diagram of a document processor operative to perform the method of FIG.2

### DETAILED DESCRIPTION OF THE INVENTION

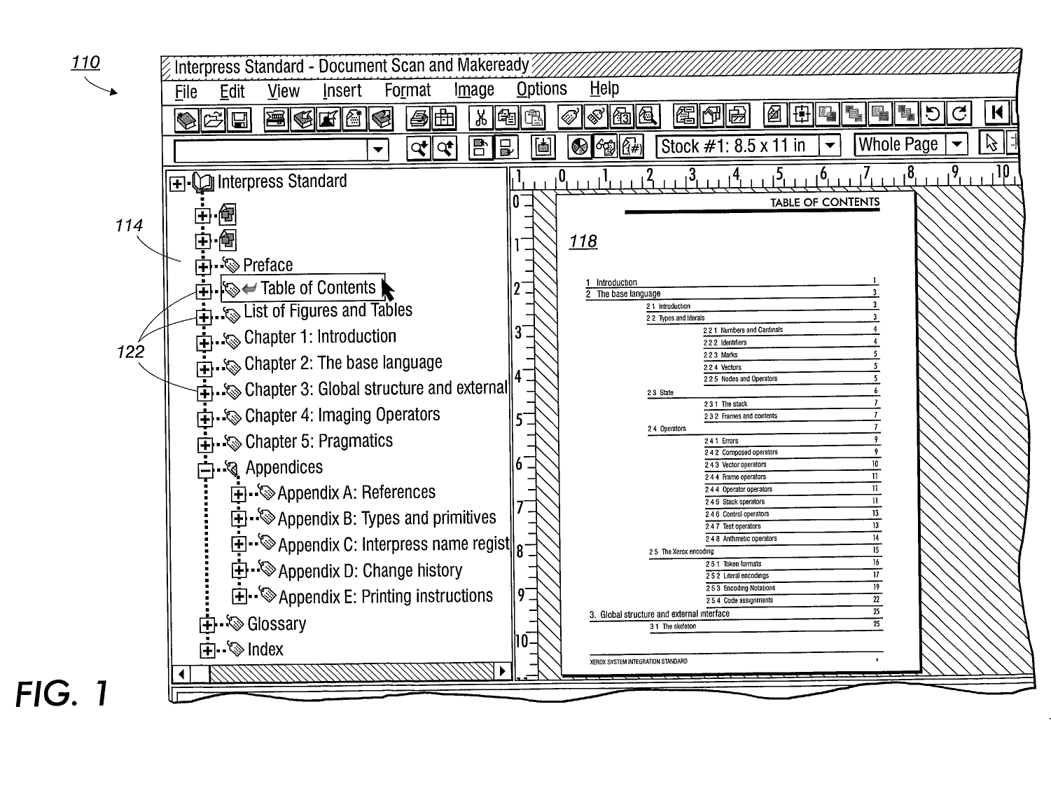

Referring to FIG. 1, a document display or processing device, such as, for example, a raster document manager, or a scan and makeready tool 110, associated with, for example, a document, or image processor (see FIG.7) is operative to receive and display an image of a document. Additionally, the raster document manager or scan and makeready tool 110 is operative to do many document processing tasks, such as, for example, character recognition, document editing, and document indexing. For instance, an electronic table of contents 114 is created in association with an electronic document 118 using the scan and makeready tool 110.

In prior art systems, the electronic table of contents 114 is created manually. As explained above, an operator reviews the electronic document 118 and manually enters a description of each significant sub-section of the document, along with sub-section location information, into the electronic table of contents 114.

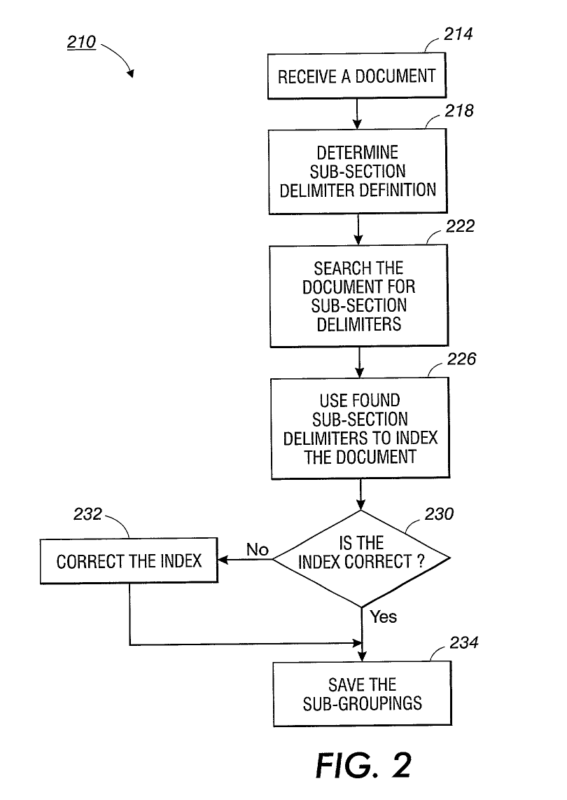

Referring to FIG. 2, a method 210 operative to automatically generate an electronic index or table of contents 114 for an electronic document 118 begins when a document is received 214. The document is reviewed for sub-section delimiter determination 218. In the sub-section delimiter determination 218, a description of, for example, chapter titles, is determined. For instance, in a particular document, chapter titles are underlined and in a larger font than other text. Therefore, a chapter delimiter definition for the document would include underlined text and a font size above a font size threshold. Other kinds of sub-section delimiter definitions are described in detail is below. After sub-section delimiters are defined, the document is searched in a document sub-section delimiter-searching procedure 222. The location and content of delimiters found during the delimiter-searching procedure 222 are recorded, for example, in a document processor memory. In an index creation procedure 226, the recorded information is used to create an electronic index or table of contents of the document. For example, the content of a delimiter is a chapter title. The chapter title is entered and eventually displayed in the electronic index or table of contents 114. Chapter titles are displayed, for example, in the order in which they appear in the document In the electronic index or table of contents 114, chapter title displays include, for example, hyperlinks to related portions of the document. For instance, clicking on a chapter title is interpreted as a command to display a related page or portion of the document.

Optionally, in an index verification procedure 230, an operator is able to verify the accuracy and appropriateness of the generated electronic index or table of contents 114. If the operator is satisfied with the quality of the electronic index 114, the electronic index is saved in association with the document in an index saving procedure 234. For example, the electronic index is saved in a description file associated with the document. If the operator finds errors in the electronic index 114, the operator may make changes to the electronic index. For example, the operator may delete one or more of the listed delimiters 122 (chapter or sub-section headings). For instance, some text may have fit the determined delimiter description while not actually being a chapter or sub-section delimiter. Some text in the document may be underlined for emphasis, rather than because the text is a chapter heading, and therefore be mistakenly included in the table of contents. Alternatively, the operator may manually add one or more sub-section headings to the electronic index. For instance, an important table or figure is beneficially listed in the electronic index, however the table or figure is not associated with a sub-section heading as defined in the determined delimiter definition. For this reason, the table or figure may be overlooked by the automatic delimiter-searching procedure 226. Therefore, the operator is provided with tools that allow the addition of a description of the table or figure or other overlooked portion, and a means for entering a hyperlink to the location of the figure within the document. Once the operator is satisfied with the accuracy and completeness of the electronic index, the index is saved in association with the document in the index saving procedure 234.

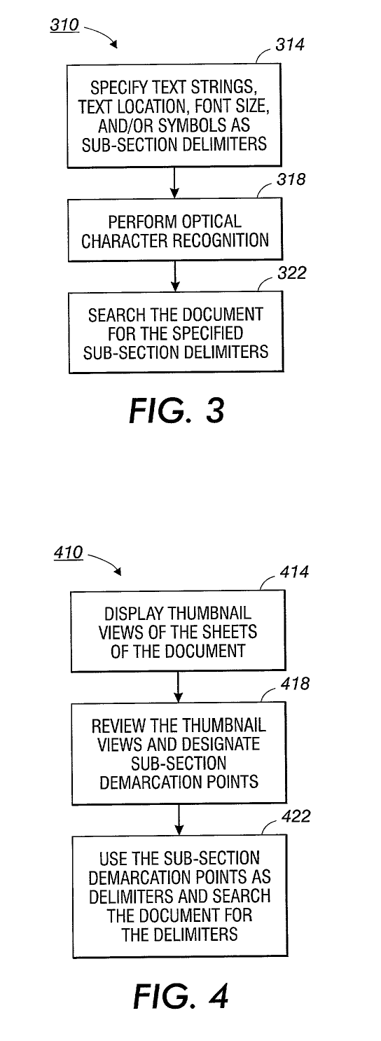

Some embodiments of delimiter definition 218 and the related searching 222 are now described in greater detail. Referring to FIG. 3, a first embodiment 310 of the delimiter definition and searching procedures 218, 222 includes delimiter characteristic description 310. Delimiter characteristics may be selected from a list of anticipated characteristics, entered through manual keyword entry, entered by selection, or entered by other means. Additionally, delimiter characteristics can be combined to better distinguish delimiters from other document text. For example, possible delimiter characteristics include font size, font type, text strings, text position, and symbols For instance, chapter headings may be larger than other document text, chapter headings may be printed in a different font that other document text, or with underlining or italics In some documents, chapter or sub-section headings may be positioned in a consistent portion of a document page. In other documents, sub-sections may be labeled with a particular word, such as, for example, —CHAPTER—or—Section—followed by a number. Any of these characteristics may be entered as all or part of a delimiter definition. A delimiter definition may include a combination of characteristics, such as font size=22-point AND text location=10 centimeters from a top edge of a page. Where such a definition is used, 22-point text that is at some other location on a document page will not be recorded as defining a sub-section. Only text meeting both the font size and location characteristics will be recorded.

Optionally, complex delimiter definitions are predefined and stored under individual names. For example, a delimiter definition may be common to all or most documents from a particular source. Therefore a sub-section delimiter definition is predefined and stored, for example, under a name of the source.

In an OCR or DR procedure 318, document raster data is processed through an optical character recognition or a document recognition function to generate a text, text location, object, and object location description of the document. Optionally, document characteristics such as font, font size and other text and document parameters are also recognized and included with the text and object description of the document. With document text and characteristics recognized, and with a delimiter definition determined, the document is searched in a sub-section delimiter-searching procedure 322. Information regarding each portion of the document that meets the delimiter definition criteria is recorded. For example, for each occurrence of 22-point text in an underlined Times Roman font, text and location information are recorded in, for example, a system memory.

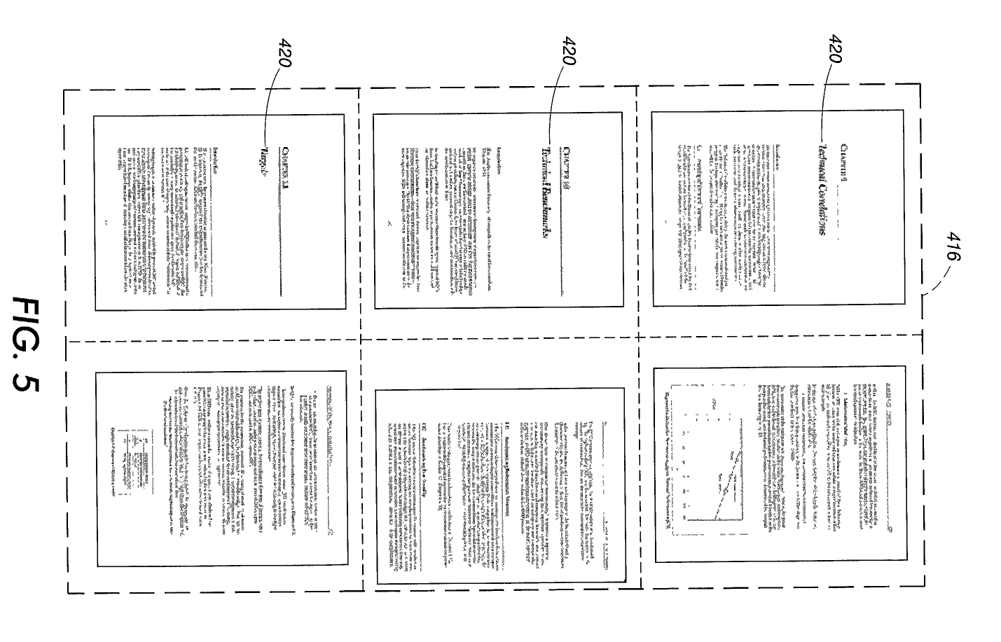

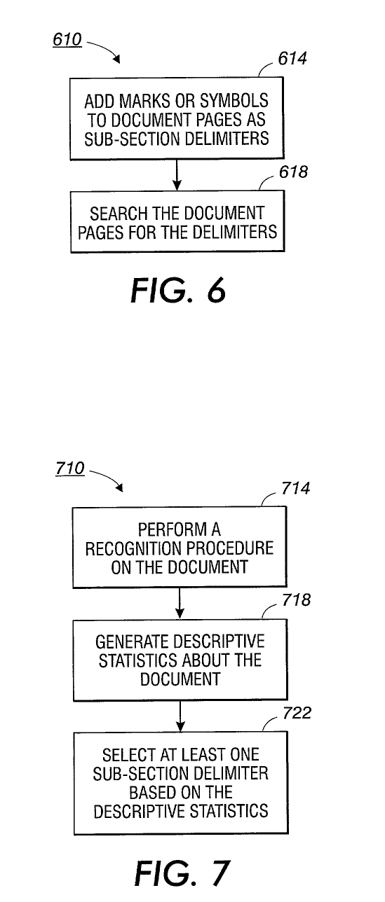

Referring to FIG. 4, in a less automated embodiment, the delimiter definition procedure 218 includes thumbnail display 414. In the thumbnail display 414, a plurality of document pages is displayed to an operator. For example, referring to FIG. 5, a plurality 416 of document pages is displayed for the operators review. The pages are displayed at a reduced resolution so that a large number of pages may be reviewed at once. Even at the reduced resolution, in a thumbnail review 418 the operator is able to quickly recognize and designate sheets, pages or portions thereof, which contain chapter headings 420.

In a document-searching procedure 422, information regarding each designated sheet, page, or portion of the document is recorded. For example, where pages or sheets are designated as containing the beginning of chapters or sub-sections, page location information is recorded. Then, in the index creation procedure 226, the operator is asked to manually enter sub-section title information. Alternatively, specific locations within a sheet or a page are designated, for example during the thumbnail review 418. Text from the designated locations is recognized (e.g. by OCR) and recorded in the document-searching procedure 422. In yet another alternative, after information regarding each designated sheet, page, or portion of the document is recorded, a more detailed view of each designated page or section is presented to the operator. The operator selects text to be used in the electronic index as a chapter or section title from the more detailed view. That text information is recognized (e.g. OCR) and automatically used as the sub-section title during index creation.

In yet another embodiment 610, predetermined sub-section delimiter symbols are added to a document prior to scanning in a demarcation symbol addition procedure 614. For example, stickers containing bar codes or data glyphs are added to a paper version of a document prior to document scanning. Alternatively, the demarcation symbols are added electronically, for example, when the document is first created In a sub-section delimiter-searching procedure 618, information regarding each portion of the document that contains a demarcation symbol is recorded. In some embodiments, just page numbers are recorded. In other embodiments, text at a predetermined position relative to the symbol is recorded. In the latter case, the text is used as a sub-section title at index-creating 226. In the former case, an operator may be asked to manually enter, or select, (as described above) sub-section title information during index-creation 226.

In some embodiments of the method 210 operative to automatically generate an electronic index or table of contents the delimiter definition procedure 218 can be further automated.

For example, referring to FIG. 7, a procedure 710 operative to automatically determine a delimiter definition includes performing document or optical character recognition 714 on the document and collecting or generating descriptive statistics 718 about the document. A delimiter definition is selected 722 based on the descriptive statistics. For example, a point size of each character in the document is tallied. The largest point size included in the document, which occurs above a threshold number of times, is taken to be the point size of sub-section headings and is therefore included in a delimiter definition. The threshold or other filter may be required to rule out a main document title as an example of a chapter title. Additionally, the threshold or other filter is used to rule out font size designations that result from errors in optical character recognition.

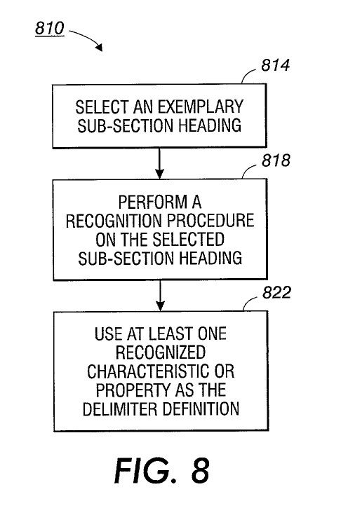

Referring to FIG. 8, another procedure 810 operative to automatically determine a delimiter definition includes selecting 814 an exemplary title or section heading, performing a recognition procedure 818 on the exemplary title or section heading and using recognized properties of the exemplary title or section heading as a delimiter definition 822. For example, an operator is shown thumbnail view of pages of a document. The operator reviews the pages in search of a chapter title. When a chapter title is found, the operator selects 814 the chapter title (by surrounding the title with a selection box, highlighting the selected test, or by other means). Optical character recognition 818 or similar processes are applied to the selected text and descriptive information is extracted from the text. For example, one or more of font size, font type, character color, and text location is recognized. At least one of the recognized characteristics is used as a delimiter definition. From this point processing continues as described in one or more of the previously described embodiments.

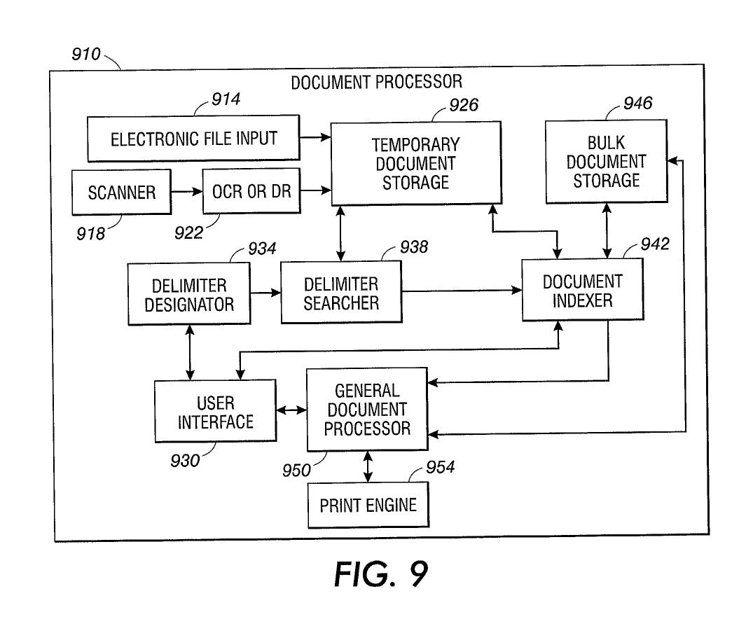

Referring to FIG. 9, an exemplary document processor 910 operative to perform the method 210 to automatically generate an electronic index or table of contents 114 for an electronic document 118 includes a means for receiving document data, such as, for example, an electronic file input device 914 or a document scanner 918. Where the document scanner 718 is used, the document scanner 918 communicates with a recognition module 922, such as an optical character recognition module and/or a document recognition module. Of course, an intermediate storage device (not shown) may be inserted between the scanner and the recognition module For example, scanning may take place at a remote location. Scanned document data may be stored in a computer storage device such as magnetic or optical media or communicated to the document processor via a computer network. The recognition module processes raster or bitmap information delivered from the scanner to generate character and position information about the document. For example, character and position information may include the location of text on a page, the characters that make up the text, the size of the text, and the font or style of the characters. Whether document data is delivered via the scanner 918 and recognition module 922, or is delivered through the electronic file input device 914 in a format that already includes character and position information, character and position information is stored in a temporary storage device 726. The temporary storage device 926 is, for example, a computer memory.

The exemplary document processor 910 also includes a user interface 930, a delimiter designation module 934, a delimiter-searching module 938, a document indexer module 942, a bulk storage device 946, general document processing modules 950, and a print engine 954.

The user interface can be any type of user interface, such as those known in the art. For example, the user interface 930 may include a display screen, a keyboard and a pointing device, such as, for example, a mouse. An operator (not shown) communicates with the delimiter designator module 934, the general document processing modules 950, as well as other document processor modules through the user interface 930.

The delimiter designator module 934 is a tool or wizard operative to assist the operator in defining a sub-section delimiter. For example, the delimiter designator module 934 displays predefined delimiter definitions, displays a list of possible delimiter definition components, and accepts delimiter definition input from the operator.

Predefined delimiters definitions are definitions known to be applicable to, for example, documents from a particular source. For example, customer A and author C are known to produce documents in particular formats. Therefore, a delimiter definition is generated for each of those document sources and stored in association with a label related to the respective sources.

Possible delimiter components are descriptors that differentiate sub-sections or sub-section titles from the rest of the document. For example, symbols, fonts, font sizes, text, text location, and text styles (e.g. underlined, italics) are all possible delimiter components. Delimiter definition input can be in any computer input form. For example, mouse click selections and keyboard inputs are used to select predefined delimiter definitions, request automatic, statistics based, delimiter definition, select and logically combined delimiter components, select exemplary sub-section headings, and to enter definition components such as text strings, and text locations.

The delimiter-searching module 938 receives a delimiter definition from the delimiter definition module 934 and accesses document information stored in the temporary storage device. The delimiter-searching module 738 reviews the accessed information in search of portions of the document that fit the received delimiter definition. Information is recorded regarding each portion of the document that matches the received delimiter definition. For example, the location and text content of each matching portion is recorded. The recorded information is passed to the document indexer 942.

The document indexer 942 uses the recorded information to generate an electronic index 114 for the document. When processing is complete, the document is stored in association with the electronic index. For example, the document 118 and index 114 are stored in the bulk storage device 946. Optionally the electronic index is displayed on the user interface and the operator is given the opportunity to modify or correct the automatically generated electronic index, either before or after the index is stored.

The bulk storage device 946 may include, for example, a computer hard drive. Alternatively, the bulk storage device 946 may include a computer network and networked components.

The general document processing functions 950 are known in the art. The general document processing functions 950 include, but are not limited to, document editing and document rendering functions. For example, the general document processing functions may be used to deliver a document or a portion of a document (located, perhaps, through the use of the electronic index) to the print engine 954.

The print engine can be any image or document-rendering device For example, in a xerographic environment, the print engine 954 is a xerographic printer. Xerographic printers are known in the art to comprise a fuser, a developer and an imaging member In other environments, the print engine may be another device, such as, for example, an ink jet, lithographic, or ionographic printer.

Of course, document processors that are operative to perform the method 210 operative to automatically generate an electronic index or table of contents 114 can be implemented in a number of ways. In the exemplary document processor 910, the delimiter designator module 934, delimiter-searching module 938, document indexer 942 and the general document processor functions 950 are implemented in software that is stored in a computer memory and run on a microprocessor, digital signal processor, or other computational device. Other components of the document processor are known in the art to include both hardware and software components. Obviously the functions of these modules can be distributed over other functional blocks and organized differently and still embody the invention.

The invention has been described with reference to particular embodiments. Modifications and alterations will occur to others upon reading and understanding this specification. It is intended that all such modifications and alterations are included insofar as they come within the scope of the appended claims or equivalents thereof.

What is claimed is:

1. A method operative to automatically generate an index for a document, the method comprising:
determining a sub-section delimiter definition;
searching the document to find occurrences of the defined sub-section delimiter; and,
creating the index for the document from the found sub-section delimiter occurrences.

2. The method operative to automatically generate an index for a document of claim 1 wherein determining a sub-section delimiter compromises indicating at least one of a font size, a font, a text string, a text location, a symbol, and a specific point within the document.

3. The method operative to automatically generate an index for a document of claim 1 wherein determining a sub-section delimiter compromises using a symbol representing a demarcation point on a printed version of the document as the sub-section delimiter.

4. The method operative to automatically generate an index for a document of claim 1 wherein searching the document comprises:
generating an electronic version of the document; and,
searching the electronic version of the document for one of characters and objects that match the defined sub-section delimiter.

5. The method operative to automatically generate an index for a document of claim 4 wherein generating a n electronic version of the document comprises:
scanning a printed version of the document to generate scan data, and,
performing one of optical character recognition functions and document recognition functions on the scan data to generate an electronic version of the document.

6. The method operative to automatically generate an index for a document of claim 1 further comprising:
displaying the created index;
checking that the displayed index is correct; and,
correcting the index.

7. The method operative to automatically generate an index for a document of claim 1 wherein determining a sub-section delimiter definition comprises:
selecting an exemplary sub-section title;
performing one of: document recognition and optical character recognition on the selected exemplary sub-section title, and
using at least one recognized property of the exempary sub-section title as a subsection delimiter definition.

8. The method operative to automatically generate an index for a document of claim 1 wherein determining a sub-section delimiter definition comprises:
displaying a plurality of document pages on a user interface;
selecting at least one demarcation point on at least one of the plurality of pages and,
using the at least one demarcation point as the defined sub-section delimiter.

9. A document processor operative to automatically generate an index for a document, the document processor comprising:
a document input device operative to provide an electronic version of a document;
a document storage device operative to store the electronic version of the document;
a delimiter searcher operative to search for and record information regarding occurrences of a defined delimiter within the electronic version of the document; and
a document divider operative to divide the document into sub-sections based on the recorded information regarding occurrences of the defined delimiter.

10. The document processor of claim 9 further comprising:
a user interface operative to transfer information between a document processor operator and portions of the document processor; and;
a delimiter designator module operative to communicate with the document processor operator through the user interface in order to generate at least one delimiter designation.

11. The document processor of claim 10 wherein the delimiter designator is operative to accept an indication of at least one of a font size, a font, a text string, a text location, a symbol, and a specific point within the document as a delimiter designation.

12. The document processor of claim 10 wherein the delimiter designator is operative to display a plurality of document portions on the user interface for the document operator to view while determining the at least one delimiter designation.

13. The document processor of claim 12 wherein the user interface is operative to receive demarcation point designations from the document processor operator and deliver the demarcation point designations to the delimiter designator as delimiter designations.

14. The document processor of claim 9 wherein the delimiter searcher is operative to search for a defined delimiter comprising a symbol selected from a barcode and a data glyph.

15. The document processor of claim 9 further comprising a print engine operative to print sub-sections of the document.

16. The document processor of claim 15, operating in a xerographic environment, wherein the print engine comprises a xerographic printer.

17. The document processor of claim 15 wherein the print engine comprises an inkjet printer.

18. A method for dividing a document into separate sections, the method comprising:
scanning the document to generate scanned document data,
performing recognition functions on the scanned document data to generate a recognized version of the document
defining a sub-section delimiter;
searching the recognized version to find occurrences of the defined sub-section delimiter; and,
using found sub-section delimiter occurrences to separate the document into the separate sections.

19. The method for dividing a scanned document into separate sections of claim 18 wherein defining a sub-section delimiter comprises at least one of building a sub-section delimiter from a list of predetermined potential sub-section delimiter components, performing statistical analysis on recognized characters to select characteristics that are most likely to be associated with sub-section delimiters, entering a sub-section delimiter through keyboard keystrokes, entering a sub-section delimiter by selecting symbols on a displayed portion of the electronic version of the document, and designating at least one demarcation point on at least one displayed portion of the electronic document to create a list of demarcation points to be used as a set of delimiter definitions.

20. The method for dividing a scanned document into separate sections of claim 18 wherein defining a sub-section delimiter comprises marking a paper version of the document with at least one special demarcation symbol prior to scanning the document.
